(19) United States
(12) Patent Application Publication
(10) Pub. No.: US 2026/0063779 A1
(43) Pub. Date: Mar. 5, 2026

(54) Method for Monitoring the State of a Distance Sensor Operating Based on Propagation Time Determination of Electromagnetic Waves

(71) Applicant: KROHNE Messtechnik GmbH, Duisburg (DE)

(72) Inventors: Pierre Gembaczka, Duisburg (DE); Penelope Mück, Duisburg (DE); Fabian Dübler, Bochum (DE); Christian Schulz, Bochum (DE); Christoph Schmits, Dortmund (DE)

(21) Appl. No.: 19/312,600

(22) Filed: Aug. 28, 2025

(30) Foreign Application Priority Data
Aug. 29, 2024 (DE) 102024124753.3

(51) Int. Cl. G01S 13/32; G01S 7/35

(52) U.S. Cl. CPC G01S 13/32; G01S 7/352

(57) ABSTRACT

Monitoring the status of a distance sensor operating by determining the transit time of electromagnetic waves includes: during operation, detecting an operating temperature of the distance sensor and determining an operating frequency spectrum of a ringing signal generated and detected at the operating temperature, wherein a reference frequency spectrum of a ringing signal generated and detected at a reference temperature in a good state of the distance sensor is stored in the distance sensor; determining an expected reference frequency spectrum from the operating temperature and the operating frequency spectrum determined at the operating temperature; comparing the reference frequency spectrum stored in the distance sensor with the expected reference frequency spectrum in a comparison step; determining a reference frequency spectrum deviation based on the comparing; determining a state deviation of the distance sensor from the reference frequency spectrum deviation; and signaling, at least indirectly, the state deviation.

### BACKGROUND OF THE INVENTION

### Field of the Invention

The invention relates to a method for condition monitoring of a distance sensor operating based on propagation time determination of electromagnetic waves, wherein in a measurement process, a transmission signal is generated by a control and evaluation unit of the distance sensor, and the transmission signal is partially emitted as an emission signal into a detection space of the distance sensor, wherein the transmission signal, through interaction with components of the distance sensor, partially returns as a parasitic ringing signal to the control and evaluation unit and is detected. In addition, the invention also relates to such a distance sensor.

### Description of Related Art

Distance sensors of the aforementioned type have been known for a long time; they are used, for example, in fill level measurement in process technology or also in object detection in the automotive field, to name just two examples. The mode of operation is based on the distance sensor—directly or indirectly—determining the propagation time of the transmission signal, which is generated by it as an electromagnetic wave, is emitted into the detection space of the distance sensor, and is at least partially reflected by an object in the detection space and returns to the distance sensor as a reflected transmission signal. Based on the known propagation speed of the electromagnetic wave, the distance of the object in the detection space to the distance sensor is then calculated.

In industrial practice, transmission signals in the GHz range are often generated; however, the choice of operating frequencies is not relevant for the considerations made here. Many distance sensors operate with free-space waves, i.e., waves that are emitted into the detection space of the distance sensor and propagate there unguided. However, there are also distance sensors in which electromagnetic waves are guided—for example by means of a waveguide or a coaxial cable—into the detection space; this is likewise irrelevant for the considerations presented here.

The signal propagation time is directly detected by some distance sensors, particularly those that emit pulses as transmission signals (pulse radar). In this case, the reception of the reflected transmission signal is detected with high temporal resolution, so that immediate propagation time information is available. Other distance sensors operate with a continuous transmission signal, the frequency of which is modulated—for example, linearly increasing—(FMCW radar, frequency modulated continuous wave). The transmission signal and the reflected transmission signal—that is, the reception signal—are then mixed, whereby the mixed signal contains frequency components of the difference frequency and the sum frequency of the transmission and reception signal. By determining the difference frequency, the propagation time can thus be indirectly inferred, since the rate of change of the frequency modulation is known. This procedure has significant advantages in signal processing.

All described distance sensors share the feature that the transmission signal generated by the control and evaluation unit, through interaction with components of the distance sensor, partially returns as a parasitic ringing signal to the control and evaluation unit and is detected there. It is a parasitic signal because it has essentially nothing to do with the actual measurement quantity of interest, namely the transmission signal that has passed through the detection space of the distance sensor, has been reflected by the object, and has returned. The ringing signal is mainly caused by self-reflection and self-conduction within the distance sensor itself and is as such hardly avoidable. Such self-reflection arises, for example, at transitions where the wave impedance changes, i.e., also when the transmission signal exits an antenna body into free space.

Since the ringing signal primarily propagates within the distance sensor, it typically arrives first at the control and evaluation unit as the initial reception signal after the transmission signal is emitted. Because the ringing signal depends on the structural characteristics of the distance sensor, the time interval between transmission and reception time changes practically not at all, which is why such a ringing signal can be relatively easily filtered out when determining the actual measurement quantity of interest, for example, by temporal windowing of reception or evaluation of reception signals.

From DE 10 2012 014 267 A1, it is known to deliberately evaluate a ringing signal in order to monitor the sealing of a cavity within the distance sensor. For this purpose, a reference value is used, which was recorded in the good state of the distance sensor, i.e., in its functional state, and this reference value is compared with a value currently recorded during normal operation of the distance sensor, which is related to the ringing signal, thereby enabling detection of changes in the state of the distance sensor.

### SUMMARY OF THE INVENTION

An object of the present invention is to develop an improved method for being able to monitor the state of a distance sensor.

This object, and other objects, are achieved in a method according to the invention with a first feature in that a reference frequency spectrum of a ringing signal, generated and detected at a reference temperature in a good state of the distance sensor, is stored in the distance sensor. The method is based on the recognition that the frequency spectrum of a ringing signal of an individual distance sensor is characteristic for that individual distance sensor, and that the ringing signal—and thus its frequency spectrum—is temperature-dependent. While the ringing signal of a distance sensor of a certain design type is essentially similar from one individual sensor to another, there are nevertheless certain characteristics and individual deviations based on unavoidable differences in the implementation of the distance sensor, for example, in the variation of transmission and temperature behavior of electronic components, but also in the variation of parameters of structural components of the distance sensor.

In any case, it has been recognized as significant that in evaluating the frequency spectrum of the ringing signal, knowledge of the temperature of the distance sensor at which the transmission signal, and thus the ringing signal, was generated is also important. The determination and storage of the sensor-specific reference frequency spectrum at reference temperature in the good state of the distance sensor is usually performed during factory calibration of the distance sensor, when it is possible to operate the sensor under defined conditions. At the same time, immediately after manufacturing the distance sensor, it can be assumed that the sensor is in flawless condition, i.e., in its good state.

The ringing signal may be the unchanged signal that has arisen through self-reflection/self-conduction, but it may also be the ringing signal that has already undergone intermediate processing, for example, the mixing with the transmission signal in an FMCW radar. What is important is only that the characteristic information about the internal transmission behavior of the distance sensor is contained in the intermediate-processed ringing signal. For simplicity, only the term “the ringing signal” is used hereinafter.

In the method, furthermore, during operation of the distance sensor—that is, when the distance sensor is installed at its place of use or also permanently mounted—the operating temperature of the distance sensor is detected, and an operating frequency spectrum of a ringing signal generated and detected at the operating temperature is determined. If the operating temperature deviates from the reference temperature, then typically the operating frequency spectrum will also deviate from the reference frequency spectrum; the two frequency spectra will have different properties due to the temperature dependence of the ringing signal.

Then, according to aspects of the invention, an expected reference frequency spectrum is determined from the operating temperature and from the operating frequency spectrum determined at the operating temperature; that is, the frequency spectrum that should be present at reference temperature if the distance sensor is still in its good state. The expected reference frequency spectrum for the distance sensor in the good state is thus derived from the information of the operating temperature and the operating frequency spectrum determined during operation at the operating temperature.

Distance sensors typically feature a hardware-based control and evaluation unit based on one or more microcontrollers and/or on one or more digital signal processors. Solutions implemented using fixed-programmable logic gates, such as Field Programmable Gate Arrays (FPGAs), are also employed. The implementations share the characteristic that they realize sampling systems in which analog signal waveforms are sampled at mostly fixed time intervals, quantized in value, and then further processed. To perform a frequency analysis, the sampled measured values are usually subjected to a digital Fourier transformation, most commonly a fast Fourier transformation (FFT), which then delivers the frequency spectra in question with amplitude and phase information of the signal.

Finally, the reference frequency spectrum stored in the distance sensor is compared with the expected reference frequency spectrum in a comparison step, and a reference frequency spectrum deviation is determined. If the distance sensor undergoes no change, i.e., essentially remains in its good state, then the reference frequency spectrum deviation will be nonexistent or at least very small. However, if there has been a change in the state of the distance sensor, in other words, a deviation from the good state of the distance sensor is present then a reference frequency spectrum deviation will be detectable, at least when the state change affects the ringing signal. For this reason, from the reference frequency spectrum deviation, a state deviation of the distance sensor can ultimately be determined. The state deviation is then at least indirectly signaled. The signaling of the state deviation may be carried out internally in the distance sensor by storing a state parameter, but the state deviation may also be shown on a display of the distance sensor or transmitted as a bus message over a fieldbus to which the distance sensor is connected to other bus participants.

It has been shown that, for example, attachments to emission elements (such as horn or drop antennas) of the distance sensor are a readily detectable state deviation—in other words, contaminations of the distance sensor—because these often directly affect the ringing signal.

There are various possibilities to derive the expected reference frequency spectrum from the operating frequency spectrum determined at operating temperature; this is the subject of the embodiments of the invention described below.

In a preferred embodiment of the method, for a plurality of different distance sensors, in particular distance sensors of the same type, multiple frequency spectra of the ringing signal are determined in the good state of the distance sensors at different temperatures. Among these multiple frequency spectra of the ringing signal is also the frequency spectrum of the ringing signal present at reference temperature. The multiple temperature-dependent frequency spectra are then stored as a frequency spectrum curve family. Through this measure, a data basis is created from which, at least in principle, it is evident which reference frequency spectrum is typically present in a distance sensor, if its operating frequency spectrum at the corresponding operating temperature exhibits a certain behavior. This data basis is typically recorded by the manufacturer of the distance sensor using a plurality of distance sensors under variation of the operating temperature. This process step does not concern the normal operation of the distance sensor and is not carried out during operation of the distance sensor.

One possible method for determining the expected reference frequency spectrum works directly with the data basis described above comprising the multiple frequency spectrum curve families. It is characterized in that, in the multiple frequency spectrum curve families, that frequency spectrum of the operating temperature is determined which shows the highest agreement with the operating frequency spectrum of the distance sensor captured at the operating temperature. As the expected reference frequency spectrum, then, the frequency spectrum of the reference temperature is determined from that frequency spectrum curve family which contains the frequency spectrum with the highest agreement. In this method, frequency spectrum comparisons must therefore be made, namely one comparison per frequency spectrum curve family, since the comparison of the operating frequency spectrum of the distance sensor actually in operation is always performed only with that frequency spectrum within a frequency spectrum curve family that also corresponds to the operating temperature, i.e., the operating temperature of the distance sensor actually in operation. This method is computationally intensive, since it must continually work with the entire data basis (memory demand) and a multitude of comparison calculations must be performed (computational load). This method variant is preferably carried out outside of the distance sensor, for example on an external control computer.

In one further development of the method, the highest agreement between two frequency spectra is determined through application of a statistical similarity analysis, in particular through calculation of a similarity measure and/or a distance measure and/or through determination of a correlation.

An alternative and preferred method for determining the expected reference frequency spectrum uses methods of machine learning, specifically with a trained artificial neural network. The artificial neural network determines the expected reference frequency spectrum, wherein the artificial neural network receives as input values the operating temperature of the distance sensor and the operating frequency spectrum of the distance sensor captured at the operating temperature. As output value, the artificial neural network delivers at least the expected reference frequency spectrum at the reference temperature. Specifically, the input vector of the artificial neural network includes, for example, a number of n amplitude values of the frequency spectrum at n frequencies, where the frequencies do not need to be specified if they are uniformly used and known. The reference temperature is typically an agreed-upon and fixed value, so it need not be an input datum in this case. Then, the output vector of the artificial neural network correspondingly provides a number of n amplitude values of the expected reference frequency spectrum at n frequencies, where again the frequencies need not be specified if they are uniformly used and known. It has been shown that the regression task of determining an expected reference frequency spectrum can be solved with a relatively small neural network, which can also be implemented on a distance sensor that is realized as a typical field device, such as a process-technical fill-level sensor.

In a further development of the method, the reference frequency spectrum recorded in the good state is likewise processed by the trained artificial neural network. The reference frequency spectrum derived through this processing by the artificial neural network is then used as the stored reference frequency spectrum. This means that, in particular, the comparison step is carried out using the derived reference frequency spectrum that has passed through the artificial neural network.

Training of the artificial neural network usually takes place centrally for one type of distance sensor at the manufacturer of the distance sensor; only the training result, i.e., the trained neural network, is then placed on the distance sensor. However, the neural network for determining the expected reference frequency spectrum may also be executed elsewhere; it does not necessarily have to be executed on the distance sensor. In a further development of the method, the artificial neural network is trained using the frequency spectra of the frequency spectrum curve families of multiple distance sensors, whereby each training input data set includes a frequency spectrum and the temperature assigned to the frequency spectrum, and whereby the training output data includes at least the reference frequency spectrum of the frequency spectrum curve family from which the frequency spectrum was used as training input data. Only temperatures and frequency spectra are referred to here, because the frequency spectra used for training are strictly speaking not obtained during normal operation, but rather under defined and controlled conditions, for example, in the factory of the distance sensor manufacturer.

A preferred design of the method provides that the frequency spectra of the frequency spectrum curve families and the temperatures assigned to the frequency spectra of the frequency spectrum curve families are normalized before their use as training data, in particular by mapping the value range of the frequency spectra and the value range of the temperatures assigned to the frequency spectra from minimum to maximum value onto a defined normalized value range. It has proven advantageous if each frequency spectrum of a frequency spectrum curve family is normalized separately, for example, mapped to an amplitude range from 0 to 1. Although this normalization causes the amplitude information between different frequency spectra to be lost, it has been found that the normalized frequency spectra remain sufficiently characteristic to be suitable for training the artificial neural network.

A further development of the method is characterized in that, in the comparison step, the reference frequency spectrum deviation is determined by application of a statistical similarity analysis, in particular by calculating a similarity measure and/or a distance measure, or by determining a correlation.

As already mentioned, the method, or the method variations, can be carried out in various places by different actors with some computational capacity. In various preferred designs of the method, the determination of the operating frequency spectrum of the ringing signal generated and detected at the operating temperature, and/or the determination of the expected reference frequency spectrum, and/or the comparison step, and/or the determination of the reference frequency spectrum deviation, and/or the determination of the state deviation is carried out by the control and evaluation unit of the distance sensor or is performed on an external computer outside the distance sensor (e.g., control computer in a fieldbus system or diagnostic server via Ethernet or cellular network).

In another preferred design of the method, the state deviation of the distance sensor is determined as a degree of contamination of the distance sensor.

Embodiments of the invention also relate to a distance sensor that operates on the basis of propagation time determination of electromagnetic waves, wherein in a measurement process a transmission signal is generated by a control and evaluation unit of the distance sensor, and the transmission signal is partially emitted as an emission signal into a detection space of the distance sensor, and wherein the transmission signal, through interaction with components of the distance sensor, partially returns as a parasitic ringing signal to the control and evaluation unit and is detected.

The stated object, and other objects, may be solved in the distance sensor by the features of the described method, i.e., in that in the distance sensor a reference frequency spectrum of a ringing signal, generated and detected at a reference temperature in a good state of the distance sensor, is stored, that during operation, in an actual state of the distance sensor, the operating temperature of the distance sensor is detected, and an operating frequency spectrum of a ringing signal, generated and detected at the operating temperature, is determined, that from the operating temperature and the operating frequency spectrum determined at the operating temperature, an expected reference frequency spectrum is determined, and that the reference frequency spectrum stored in the distance sensor is compared with the expected reference frequency spectrum in a comparison step, and a reference frequency spectrum deviation is determined, and from the reference frequency spectrum deviation a state deviation of the distance sensor is determined, and the state deviation is at least indirectly signaled.

Preferably, the control and evaluation unit comprises a trained artificial neural network, by which the expected reference frequency spectrum is determined, wherein the artificial neural network receives as input values the operating temperature of the distance sensor and the operating frequency spectrum of the distance sensor captured at the operating temperature, and wherein the artificial neural network provides at least the expected reference frequency spectrum at the reference temperature as an output value.

In a preferred design, the control and evaluation unit is configured such that the reference frequency spectrum recorded in the good state is likewise processed by the trained artificial neural network, and the reference frequency spectrum thus derived is used as the stored reference frequency spectrum, particularly in the comparison step.

In a further preferred design, the control and evaluation unit determines the reference frequency spectrum deviation in the comparison step by applying a statistical similarity analysis, in particular by calculating a similarity measure and/or a distance measure, or by determining a correlation.

In a preferred design, the distance sensor, by means of the control and evaluation unit, determines the state deviation of the distance sensor as a degree of contamination of the distance sensor.

In detail, there are now a multitude of possibilities for designing and further developing the inventive method and the inventive distance sensor. For this purpose, reference is made to the following description of embodiments in connection with the accompanying drawings.

### BRIEF DESCRIPTION OF THE DRAWINGS

FIG. 1 shows, schematically, a distance sensor known from the prior art and a method for operating the distance sensor in accordance with aspects of the present disclosure.

FIG. 2 shows, schematically, a frequency spectrum of an FMCW radar distance sensor with ringing signal and reflection signal in accordance with aspects of the present disclosure.

FIG. 3 shows, schematically, a method for condition monitoring of the distance sensor in accordance with aspects of the present disclosure.

FIGS. 4a and 4b show, schematically, reference frequency spectra of the ringing signal of various distance sensors (FIG. 4a) and the temperature dependence of the operating frequency spectrum of the ringing signal of an individual distance sensor (FIG. 4b) in accordance with aspects of the present disclosure.

FIGS. 5a and 5b show, schematically, a method for determining an expected reference frequency spectrum without the use of artificial neural networks in accordance with aspects of the present disclosure.

FIG. 6 shows, schematically, a method for determining an expected reference frequency spectrum using an artificial neural network in accordance with aspects of the present disclosure.

FIGS. 7a and 7b schematically show the use of the artificial neural network, also for deriving a reference frequency spectrum in accordance with aspects of the present disclosure.

FIGS. 8a and 8b show normalized training data for training the artificial neural network in accordance with aspects of the present disclosure.

FIGS. 9a and 9b show the effect of the trained artificial neural network on frequency spectra of different distance sensors at different temperatures (temperature compensation) in accordance with aspects of the present disclosure.

### DETAILED DESCRIPTION OF THE INVENTION

In the figures, in various aspects, a method 1 for condition monitoring of a distance sensor 2 operating based on propagation time determination of electromagnetic waves, as well as such distance sensors 2, are shown.

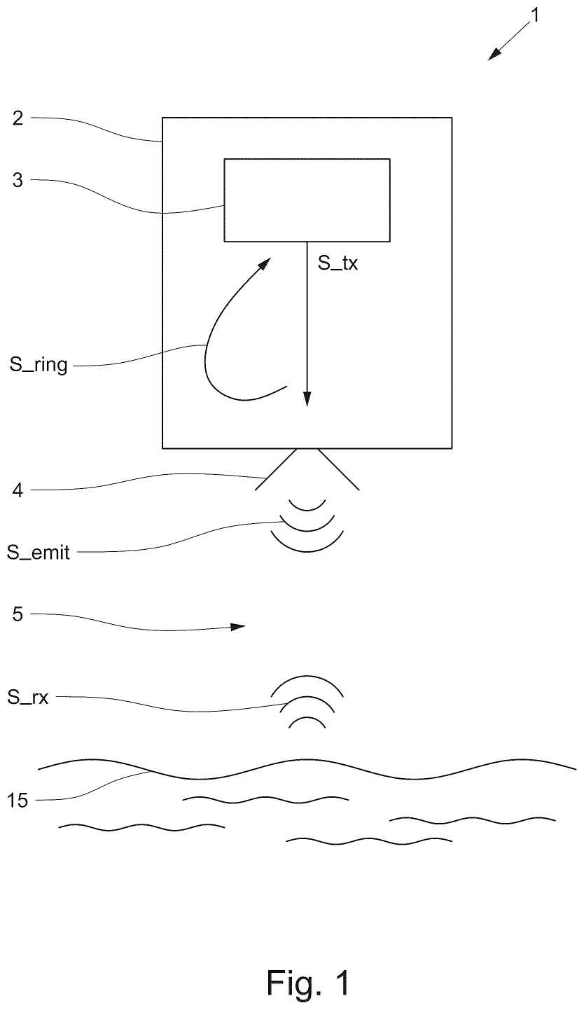

FIG. 1 shows the basic operating principle of a distance sensor 2 and a method 1 for performing distance measurement with the distance sensor 2, as is known from the prior art. FIG. 1 concerns less the condition monitoring of the distance sensor 2 and more the fundamental measuring principle for distance detection, the understanding of which is helpful for the further explanations of condition monitoring.

In a distance measuring process with the distance sensor 2, a transmission signal S_tx is generated by a control and evaluation unit 3 of the distance sensor 2, and the transmission signal S_tx is partially emitted by means of an antenna 4 as an emission signal S_emit into a detection space 5 of the distance sensor 2. In FIG. 1, the distance sensor 2 is a fill level sensor. The detection space 5 is the volume of a tank. The emission signal is at least partially reflected at a medium interface 15, and the reflected transmission signal returns to the distance sensor 2 as a reflection signal S_rx. The reflection signal is the actual measurement signal of interest in the distance measurement.

However, the transmission signal S_tx also returns partially as a parasitic ringing signal S_ring to the control and evaluation unit 3 due to interaction with components of the distance sensor 2, and is also detected there. The method 1 for condition monitoring of the distance sensor 2 presented here is essentially concerned with the use of the ringing signal S_ring.

The signal returning to the control and evaluation unit 3 is thus composed of the reflection signal S_rx important for distance measurement and the parasitic ringing signal S_ring.

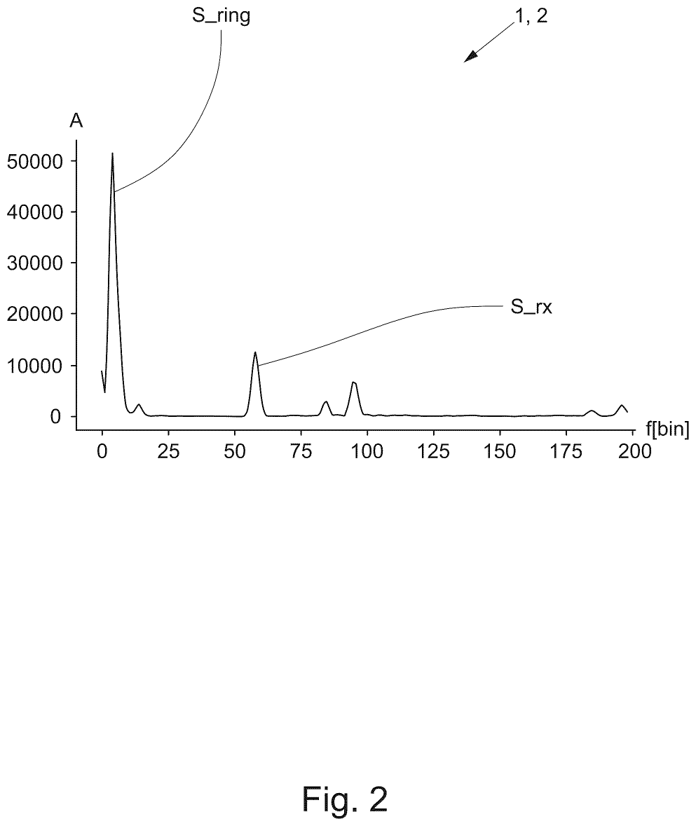

FIG. 2 shows a typical frequency spectrum of the entire reception signal of the distance sensor 2, with the component of the reflection signal S_rx required for distance measurement from an object in the detection space 5 of the distance sensor 2 and with the component of the ringing signal S_ring, which primarily originates from the structural features of the distance sensor 2 itself.

The distance sensor 2 is an FMCW radar distance sensor. The frequency in FIG. 2 is plotted on the abscissa in “bins” of a digital fast Fourier transformation, that is, frequency ranges whose width is determined by the sampling rate of the time signal analyzed for frequency and the number of sampled values entering the discrete fast Fourier transformation. The amplitude components within one bin are summed and form the total amplitude value in this frequency range. Shown is the frequency analysis of the mixed signal from the transmission signal S_tx and the reception signal, where the reception signal includes both the reflection signal S_rx and the ringing signal S_ring. Since the mixed signal contains signal components at the difference frequency of the transmission and reception signal and the frequency of the transmission signal is increased linearly over time in the present case (sawtooth-shaped time course of the frequency), the frequency simultaneously corresponds to a distance value. Accordingly, the ringing signal S_ring appears at low frequencies because it is generated directly through interaction with the distance sensor 2 and returns to the control and evaluation unit 3, and thus to a reception mixer not shown here, with minimal time delay. Due to the short propagation time, the frequency of the transmission signal has only slightly changed, so the difference frequency of the mixed ringing signal is small. The reflection signal S_rx, on the other hand, has a longer propagation time, during which the frequency of the transmission signal S_tx has changed more significantly, so the difference frequency of the mixed signal (transmission signal*reflection signal) is larger. The reflection signal at the higher frequency thus indicates a greater distance.

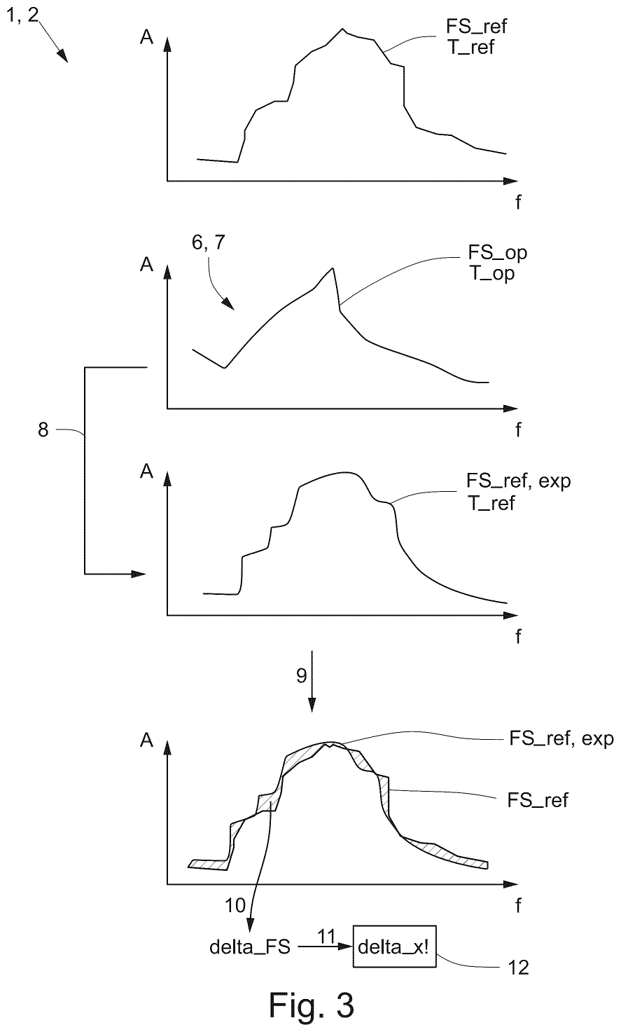

The method 1 shown in FIG. 3 is based on the idea that, through skillful evaluation of the ringing signal S_ring, the state or a change in state of the distance sensor 2 can be inferred, because the ringing signal S_ring arises primarily from interactions with the distance sensor 2 itself, and changes in the distance sensor 2 (electronic components, structural configurations, contamination) manifest in the characteristics of the ringing signal.

The method 1 provides that in the distance sensor 2, a reference frequency spectrum FS_ref of a ringing signal S_ring generated and detected at a reference temperature T_ref in the good state of the distance sensor 2 is stored (topmost spectrum in FIG. 3). Here, the reference frequency spectrum FS_ref was recorded during factory calibration, and immediately after manufacture and calibration, the distance sensor 2 is highly likely to be in the good state.

During operation of the distance sensor 2, i.e., when installed, as in the application shown in FIG. 1 as a fill level sensor, the operating temperature T_op of the distance sensor 2 is detected 6, and an operating frequency spectrum FS_op of a ringing signal S_ring generated and detected at the operating temperature T_op is determined 7 (second spectrum from the top in FIG. 3).

A step of the method 1 provides that from the operating temperature T_op and from the operating frequency spectrum FS_op determined at the operating temperature T_op, an expected reference frequency spectrum FS_ref,exp is determined 8 (third spectrum from the top in FIG. 3).

Finally, in a comparison step 9, the reference frequency spectrum FS_ref stored in the distance sensor 2 is compared with the expected reference frequency spectrum FS_ref,exp.

From the comparison of the two mentioned frequency spectra, a reference frequency spectrum deviation delta_FS is determined 10. In the illustrated case, the area (magnitude) between the two frequency spectra is calculated (bottommost depiction of two spectra in FIG. 3). From the reference frequency spectrum deviation delta_FS, a state deviation delta_x of the distance sensor 2 is determined 11, which in the illustrated embodiment corresponds to a contamination level. The relationship between the reference frequency spectrum deviation delta_FS and the contamination level as a state deviation delta_x was determined in factory trials. In the current example of contamination, deposits on the antenna 4 of the distance sensor 2 were incrementally increased. The state deviation delta_x is signaled externally via a fieldbus of the distance sensor 2 as a bus message 12 (delta_x!).

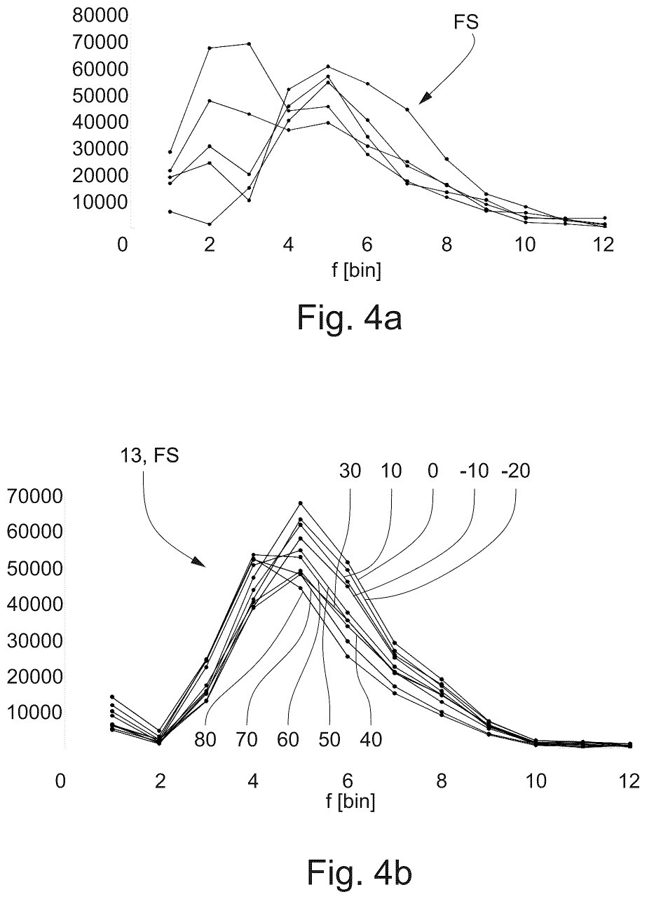

Investigations based on the developed method 1 have shown that the frequency spectrum FS of the ringing signal S_ring varies between different distance sensors 2.1-2.5 at the same operating temperature (FIG. 4a), exactly as the operating frequency spectra F_op of a ringing signal S_ring vary with the operating temperature T_op for the same distance sensor 2 (FIG. 4b). The operating temperature in FIG. 4b was varied in the range from −20° C. to +80° C. during the measurement. These individual variations from distance sensor 2 to distance sensor 2 and the temperature dependencies give rise to the need to collect a specific database. For this purpose, for a plurality of different distance sensors 2, in particular distance sensors 2 of the same type, each in good state, and the multiple temperature-dependent frequency spectra FS are stored as a set of frequency spectrum curve family 13 with the temperature-dependent frequency spectra FS of the respective distance sensor 2. A plurality of frequency spectrum curve families 13, as shown in FIG. 4b, are thus collected from different distance sensors 2 and stored. These frequency spectrum curve families 13 characterize the behavior of a distance sensor 2 of a specific design in good state.

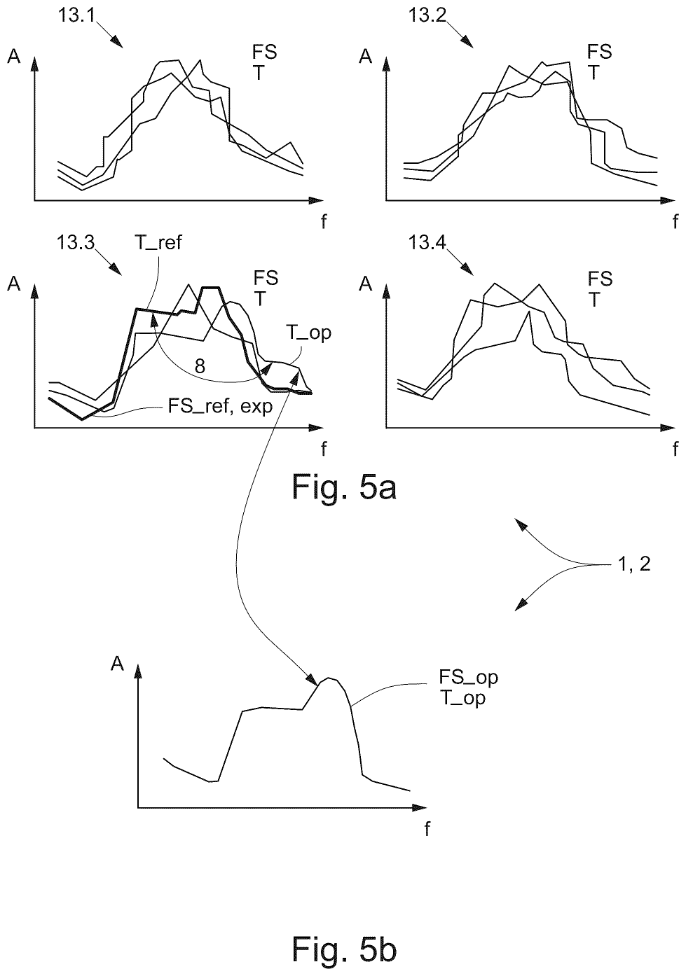

A variation for finding the expected reference frequency spectrum FS_ref,exp is shown in FIGS. 5a and 5b. FIG. 5a shows several captured frequency spectrum curve families 13.1 to 13.4 from several distance sensors 2. These are curve families 13 that have been captured at the factory by several distance sensors 2.

An operating frequency spectrum FS_op is captured at the operating temperature T_op for the distance sensor 2 during operation, as shown in FIG. 5b. From the plurality of frequency spectrum curve families 13.1 to 13.4 captured in accordance with FIG. 5a, the frequency spectrum FS of the operating temperature T_op is then determined which has the highest degree of agreement with the operating frequency spectrum FS_op captured at the operating temperature T_op of the distance sensor 2 in accordance with Fig. This can be found in the embodiment in the frequency spectrum curve family 13.3.

The expected reference frequency spectrum FS_ref,exp is then determined as the frequency spectrum of the reference temperature T_ref from the family of frequency spectrum curves 13.3 which has the highest degree of agreement with the frequency spectrum FS_op. This is the frequency spectrum FS_ref,exp that is strongly marked in the frequency spectrum curve family 13.3.

The method 1 according to FIGS. 5a and 5b works on the entire database with the plurality of temperature-dependent frequency spectra FS as frequency spectrum curve family 13.1-13.4 with the temperature-dependent frequency spectra FS of the various distance sensors 2 and is correspondingly complex. For this reason, method step 8 of finding the expected reference frequency spectrum FS_ref,exp is performed on an external diagnostic computer, to which the operating frequency spectrum FS_op captured on the distance sensor 2 at the operating temperature T_op and the associated operating temperature T_op are transmitted from the distance sensor 2 via a fieldbus connection in accordance with FIG. 5b.

The highest degree of agreement between two frequency spectra is determined by applying a statistical similarity analysis, in particular by calculating a similarity measure and/or a distance measure and/or by calculating a correlation. Here, too, the difference area between the operating frequency spectrum FS_op captured during operation of the distance sensor 2 at the operating temperature T_op according to FIG. 5b and the respective comparison operating frequency spectra according to FIG. 5a at corresponding operating temperatures T_op is used as a comparison measure.

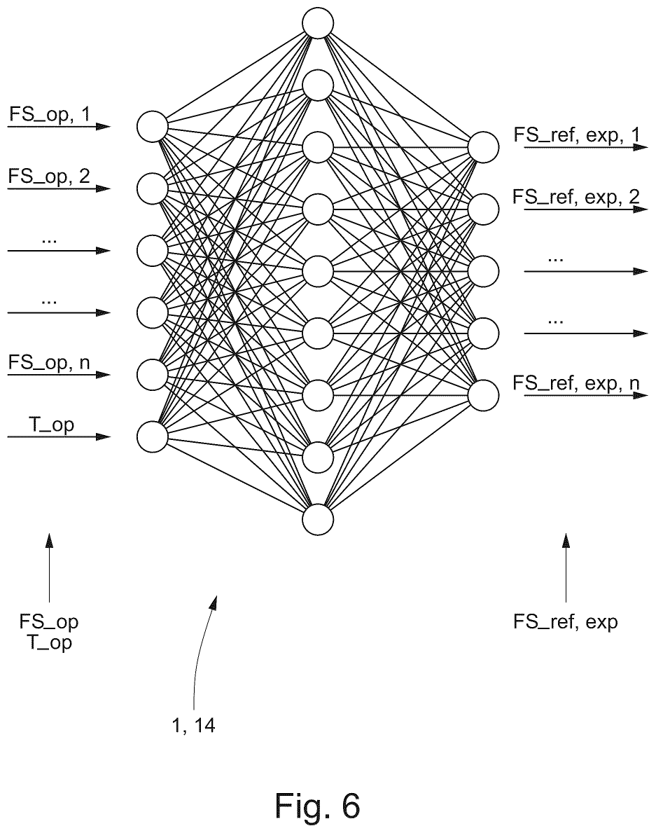

As can be seen schematically in FIG. 6, an alternative method 1 works with a trained artificial neural network 14, which is used to determine the expected reference frequency spectrum FS_ref,exp, wherein the artificial neural network 14 receives as input variables the operating temperature T_op of the distance sensor 2 and the operating frequency spectrum FS_op captured at the operating temperature T_op of the distance sensor 2, here in the form of the bin values FS_op,1 to FS_op,n. The artificial neural network 14 provides as output variables the expected reference frequency spectrum FS_ref,exp, referred to in FIG. 6 as the amplitude values FS_ref,exp,1 to FS_ref,exp,n, each at the reference temperature T_ref. The reference temperature T_ref is known and is therefore not output separately.

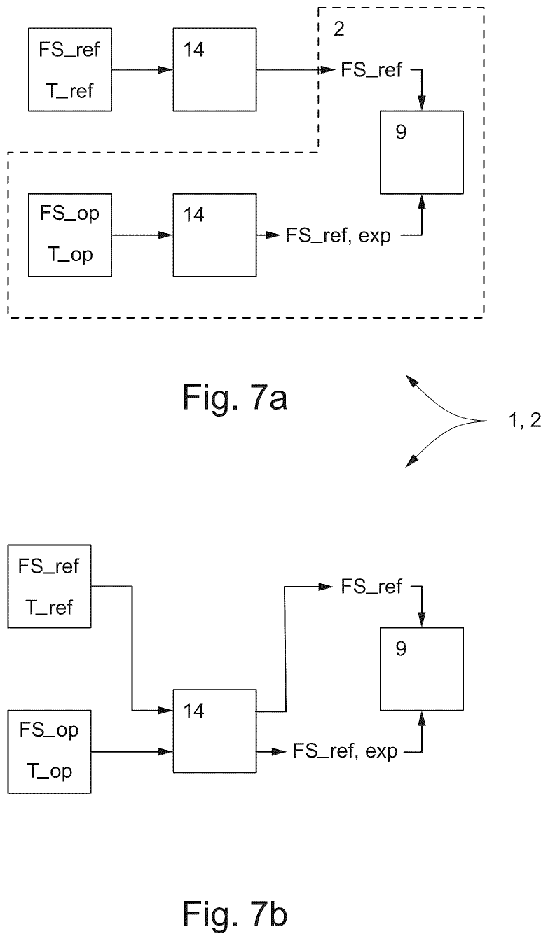

FIGS. 7a and 7b show that the reference frequency spectrum FS_ref recorded in the good state is also processed by the trained artificial neural network 14 and that the reference frequency spectrum derived in this way is used as the stored reference frequency spectrum FS_ref, i.e. it is also the item of the comparison step 9. In the embodiment according to FIG. 7a, the recorded reference frequency spectrum FS_ref is sent outside the distance sensor 2 through the artificial neural network 14, thereby obtaining the derived reference frequency spectrum FS_ref, which is then stored in the distance sensor 2. To perform comparison step 9, only the operating frequency spectra FS_op are processed with the artificial neural network 14, thus obtaining the expected reference frequency spectrum FS_ref,exp, with which comparison step 9 is then performed.

FIG. 7b shows an alternative variation of method 1. Here, the originally determined reference frequency spectrum FS_ref, as obtained directly from the discrete frequency analysis by means of a fast Fourier transformation, is stored on the distance sensor 2. Whenever method 1 is performed to monitor the status of the distance sensor 2, the stored reference frequency spectrum FS_ref is also processed by the artificial neural network 14 so that the derived reference frequency spectrum FS_ref is obtained, which then forms the basis for comparison step 9. Although this procedure requires greater computing power on the distance sensor 2, it has the advantage that the artificial neural network 14 can be replaced by an improved artificial neural network 14 during operation of the distance sensor 2 (for example, as part of a firmware update), which is not readily possible in the embodiment according to FIG. 7a.

The artificial neural networks 14 are trained with the frequency spectra FS of the frequency spectrum curve families 13 of several distance sensors 2, wherein a frequency spectrum FS and the temperature T assigned to the frequency spectrum FS are used as training input data, and wherein at least the reference frequency spectrum FS_ref of the frequency spectrum curve family 13, from which the frequency spectrum FS originates as training input data, is used as training output data.

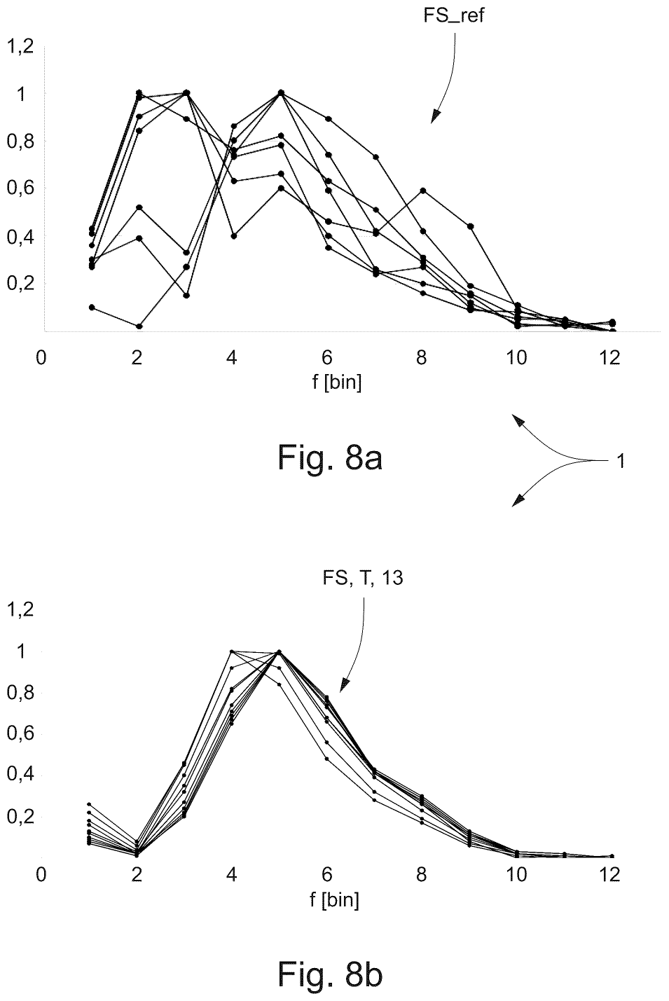

In the method 1 shown in FIGS. 8a and 8b, the frequency spectra FS of the frequency spectrum curve families 13 and the temperatures T assigned to the frequency spectra FS of the frequency spectrum curve families 13 are normalized before they are used as training data. This is done by mapping the value range of the frequency spectra FS and the value range of the temperatures T assigned to the frequency spectra FS from the minimum value to the maximum value to a defined standard value range. FIG. 8a shows reference frequency spectra FS_ref of seven different distance sensors 2 in good state, wherein each of the reference frequency spectra FS_ref has been normalized to the value range 0 to 1. FIG. 8b shows normalized frequency spectra FS of a single distance sensor 2 at different temperatures T. With this approach, relative amplitude information of the frequency spectra FS is lost, but the normalized database has a major advantage when training the artificial neural network 14.

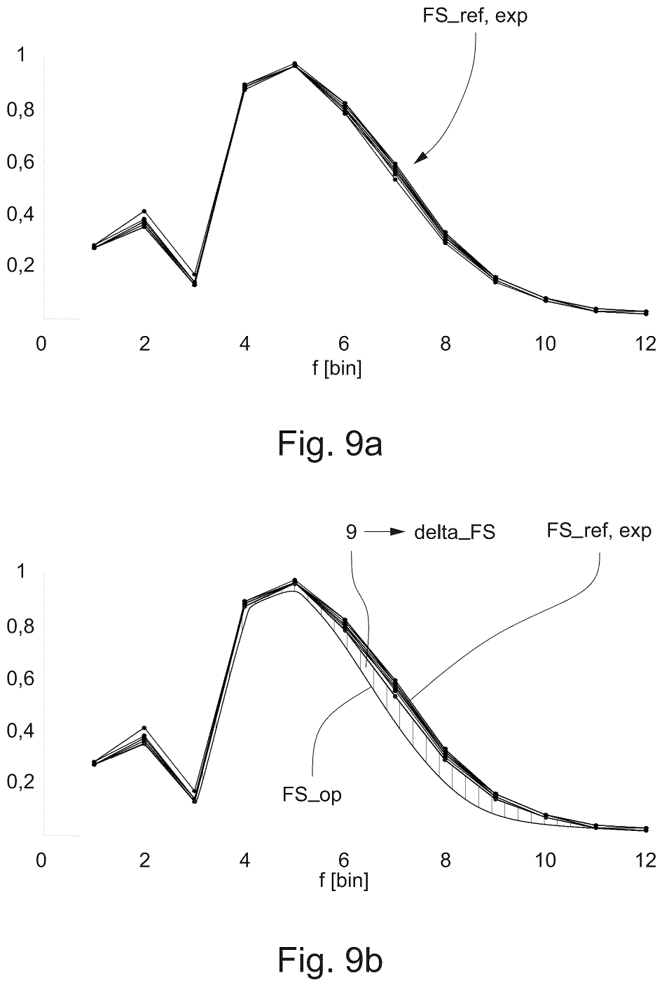

By training the artificial neural network 14 with normalized frequency spectra FS of a plurality of distance sensors 2 in good state, the artificial neural network 14 converts a mapping of frequency spectra at arbitrary temperatures to a generalized reference frequency spectrum. FIGS. 9a and 9b show what this means. FIG. 9a shows a plurality of expected reference frequency spectra FS_ref,exp, which the artificial neural network 14, trained as described above, calculates when different operating frequency spectra FS_op at different operating temperatures T_op are used as input signals from different distance sensors 2 in good state. The input frequency spectra FS_op are mapped by the artificial neural network 14 with a high degree of conformity to generalized and normalized expected reference frequency spectrum FS_ref,exp, wherein the variation between the expected reference frequency spectra is very small; the expected reference frequency spectra FS_ref,exp are practically identical. Due to the mapping behavior of the artificial neural network 14 shown above, which maps arbitrary frequency spectra obtained at different temperatures in good state from different distance sensors 2 to a single normalized and generalized expected reference frequency spectrum with good approximation, it is also justified to say that temperature compensation of frequency spectra is achieved with the artificial neural network 14.

FIG. 9b shows the expected reference frequency spectra FS_ref,exp once again. In addition, an operating frequency spectrum FS_op is shown, which has also passed through the artificial neural network 14. However, the operating frequency spectrum FS_op originates from a distance sensor 2 that is no longer in good state due to contamination of its antenna 4. A clear deviation can be seen between the operating frequency spectrum mapped by the artificial neural network 14 and the expected reference frequency spectra. In actual operation of the distance sensor 2, only one of the expected reference frequency spectra FS_ref,exp shown in FIG. 9b would be calculated. In comparison step 9, the reference frequency spectrum deviation delta_FS is calculated as the area between the expected reference frequency spectrum FS_ref,exp and the operating frequency spectrum FS_op, which has also passed through the artificial neural network 14.

### REFERENCE NUMBERS

1 Method
2 Distance Sensor
3 Control and evaluation unit
4 Antenna
5 Detection space
6 Detection of operating temperature
7 Determination of operating frequency spectrum
8 Determination of expected reference frequency spectrum
9 Comparison of the reference frequency spectrum to the expected reference frequency spectrum
10 Determination of the reference frequency spectrum deviation
11 Determination of the state deviation of the distance sensor
12 Signaling the state deviation
13 Frequency spectrum curve family
14 Trained artificial neural network
15 Medium boundary layer
16 S_tx—Transmission signal
17 S_rx—Reflection signal
18 S_emit—Emission signal
19 S_ring—Ringing signal
20 T_ref—Reference temperature
21 FS_ref—Reference frequency spectrum
22 T_op—Operating temperature
23 FS_op—Operating frequency spectrum
24 FS_ref,exp—Expected reference frequency spectrum
25 delta_FS—Reference frequency spectrum deviation
26 delta_x—State deviation

What is claimed is:

1. A method for monitoring the state of a distance sensor operating based on a propagation time determination of electromagnetic waves, wherein during a measurement process a transmission signal is generated by a control and evaluation unit of the distance sensor, and the transmission signal is partially emitted as an emission signal into a detection space of the distance sensor, wherein the transmission signal returns partially as a parasitic ringing signal to the control and evaluation unit through interaction with components of the distance sensor and is detected, the method comprising:
during operation, in an actual state of the distance sensor, detecting an operating temperature of the distance sensor and determining an operating frequency spectrum of a ringing signal generated and detected at the operating temperature, wherein a reference frequency spectrum of a ringing signal generated and detected at a reference temperature in a good state of the distance sensor is stored in the distance sensor,
determining an expected reference frequency spectrum from the operating temperature and the operating frequency spectrum determined at the operating temperature,
comparing the reference frequency spectrum stored in the distance sensor with the expected reference frequency spectrum in a comparison step,
determining a reference frequency spectrum deviation based on the comparing,
determining a state deviation of the distance sensor from the reference frequency spectrum deviation, and
signaling, at least indirectly, the state deviation.

2. The method according to claim 1, wherein for a plurality of different distance sensors of a same design, several temperature-dependent frequency spectra of the ringing signal are determined at different temperatures in the good state of the plurality of different distance sensors, and the several temperature-dependent frequency spectra are stored as a frequency spectrum curve family with the temperature-dependent frequency spectra of the respective distance sensor.

3. The method according to claim 2, wherein from the multiple frequency spectrum curve families, a frequency spectrum of the operating temperature is determined which has the highest agreement with the operating frequency spectrum of the distance sensor detected at the operating temperature, wherein the expected reference frequency spectrum is then determined as the frequency spectrum of the reference temperature from that frequency spectrum curve family, which shows the highest agreement with the frequency spectrum.

4. The method according to claim 3, wherein the highest agreement between two frequency spectra is determined by application of a statistical similarity analysis, by calculation of a similarity measure and/or a distance measure and/or by calculation of a correlation.

5. The method according to claim 2, wherein the expected reference frequency spectrum is determined using a trained artificial neural network, wherein the artificial neural network receives as input values the operating temperature of the distance sensor and the operating frequency spectrum of the distance sensor determined at the operating temperature, and the artificial neural network provides at least the expected reference frequency spectrum at the reference temperature as an output value.

6. The method according to claim 5, wherein the reference frequency spectrum recorded in the good state is also processed by the trained artificial neural network, and the thus derived reference frequency spectrum is used as the stored reference frequency spectrum.

7. The method according to claim 5, wherein the artificial neural network is trained with the frequency spectra of the frequency spectrum curve families of several distance sensors, wherein each training input data includes a frequency spectrum and the temperature assigned to the frequency spectrum, and wherein the training output data comprises at least the reference frequency spectrum of the frequency spectrum curve family from which the frequency spectrum as training input data originates.

8. The method according to claim 7, wherein the frequency spectra of the frequency spectrum curve families and the temperatures assigned to the frequency spectra of the frequency spectrum curve families are normalized before their use as training data by mapping the value range of the frequency spectra and the value range of the temperatures assigned to the frequency spectra from minimum to maximum to a defined normalized value range.

9. The method according to claim 1, wherein in the comparison step, the reference frequency spectrum deviation is determined by application of a statistical similarity analysis, by calculation of a similarity measure and/or a distance measure and/or by calculation of a correlation.

10. The method according to claim 1, wherein the determination of the operating frequency spectrum of the ringing signal generated and detected at the operating temperature, and/or the determination of the expected reference frequency spectrum, and/or the comparison step, and/or the determination of the reference frequency spectrum deviation, and/or the determination of the state deviation, is carried out by the control and evaluation unit of the distance sensor or takes place on an external computer outside the distance sensor.

11. The method according to claim 1, wherein the state deviation of the distance sensor is determined as a degree of contamination of the distance sensor.

12. A distance sensor configured to operate based on a propagation time determination of electromagnetic waves, wherein during a measurement process a transmission signal is generated by a control and evaluation unit of the distance sensor and the transmission signal is partially emitted as an emission signal into a detection space of the distance sensor, wherein the transmission signal returns partially as a parasitic ringing signal to the control and evaluation unit through interaction with components of the distance sensor and is detected,
wherein a reference frequency spectrum of a ringing signal generated and detected at a reference temperature in a good state of the distance sensor is stored in the distance sensor, and during operation, in an actual state of the distance sensor, the operating temperature is detected and an operating frequency spectrum of a ringing signal generated and detected at the operating temperature is determined,
wherein an expected reference frequency spectrum is determined from the operating temperature and the operating frequency spectrum determined at the operating temperature, the stored reference frequency spectrum in the distance sensor is compared with the expected reference frequency spectrum in a comparison step, a reference frequency spectrum deviation is determined from the comparison step, a state deviation of the distance sensor is determined from the reference frequency spectrum deviation, and the state deviation is at least indirectly signaled.

13. The distance sensor according to claim 12, wherein the control and evaluation unit comprises a trained artificial neural network with which the expected reference frequency spectrum is determined, wherein the artificial neural network receives as input values the operating temperature of the distance sensor and the operating frequency spectrum of the distance sensor detected at the operating temperature, and wherein the artificial neural network delivers as output value at least the expected reference frequency spectrum at the reference temperature.

14. The distance sensor according to claim 13, wherein the reference frequency spectrum recorded in the good state is likewise processed by the trained artificial neural network, and the thus derived reference frequency spectrum is used as the stored reference frequency spectrum.

15. The distance sensor according to claim 13, wherein the artificial neural network has been trained with frequency spectra of frequency spectrum curve families of several distance sensors, wherein each training input data includes a frequency spectrum and the temperature assigned to the frequency spectrum, and wherein the training output data comprises at least the reference frequency spectrum of the frequency spectrum curve family from which the frequency spectrum as training input data originates.

16. The distance sensor according to claim 12, wherein the control and evaluation unit, in the comparison step, determines the reference frequency spectrum deviation by application of a statistical similarity analysis, statistical similarity analysis, by calculation of a similarity measure and/or a distance measure and/or by calculation of a correlation.

17. The distance sensor according to claim 12, wherein the control and evaluation unit determines a degree of contamination of the distance sensor as the state deviation of the distance sensor.
